(19) United States
(12) Patent Application Publication
(10) Pub. No.: US 2025/0272381 A1
(43) Pub. Date: Aug. 28, 2025

(54) SECURITY DEVICE AND SYSTEM-ON-CHIP INCLUDING SECURITY DEVICE

(71) Applicant: SAMSUNG ELECTRONICS CO., LTD., Suwon-si (KR)

(72) Inventors: Hyojoon Jin, Suwon-si (KR); Jonghoon Shin, Suwon-si (KR); Kyoungmoon Ahn, Suwon-si (KR)

(21) Appl. No.: 18/972,430

(22) Filed: Dec. 6, 2024

(30) Foreign Application Priority Data
Feb. 26, 2024 (KR) 10-2024-0027507

(51) Int. Cl. G06F 21/44; G06F 21/60; G06F 21/74

(52) U.S. Cl. CPC G06F 21/44; G06F 21/604; G06F 21/74

(57) ABSTRACT

An example security device for controlling access authority of a user device includes a mode controller, an authentication controller, and an access controller. The mode controller is configured to set, based on a one-time programmable (OTP) value, a security mode indicating a method of authenticating the access authority of the user device. The authentication controller is configured to determine, based on the security mode, whether to allow access of the user device. The access controller is configured to activate or deactivate the access of the user device based on a result of the determination of the authentication controller.

### CROSS-REFERENCE TO RELATED APPLICATION

This application claims priority under 35 U.S.C. § 119 to Korean Patent Application No. 10-2024-0027507, filed on Feb. 26, 2024, in the Korean Intellectual Property Office, the disclosure of which is incorporated by reference herein in its entirety.

### BACKGROUND

Recently, security attacks on a device including a plurality of intellectual properties (IPs), such as a system-on-chip (SoC), have increased significantly. Accordingly, security requirements for an SoC have also increased. The SoC may include a security device for determining whether to allow the access of a user device used by a user performing debugging on a plurality of IPs.

The security device may use a password, a digital signature, or the like to determine whether to allow the access of the user device. A method using a password may provide higher user convenience but lower security strength than a method using a digital signature. Conversely, the method using a digital signature may provide higher security strength but lower user convenience than the method using a password. Thus, a suitable method for the security device to determine whether to allow the access of the user device is desired.

### SUMMARY

The present disclosure relates to a security device that uses an authentication method suitable for situations.

In some implementations, a security device for controlling access authority of a user device includes a mode controller configured to set, based on a one-time programmable (OTP) value, a security mode indicating a method of authenticating the access authority of the user device, an authentication controller configured to determine, based on the security mode, whether to allow access of the user device, and an access controller configured to activate or deactivate the access of the user device based on a result of the determination of the authentication controller.

In some implementations, a security device for controlling access authority of a user device to a plurality of intellectual properties (IPs) includes a mode controller configured to set a security mode of the user device for each of the plurality of IPs based on each of a plurality of OTP values, an authentication controller configured to determine, based on the security mode, whether to allow access of the user device to each of the plurality of IPs, and an access controller configured to activate or deactivate the access of the user device to each of the plurality of IPs based on a result of the determination of the authentication controller.

In some implementations, a system-on-chip (SoC) includes a plurality of IPs and a security device configured to control access authority of a user device to the plurality of IPs, wherein the security device includes a mode controller configured to set, based on an OTP value, a security mode indicating a method of authenticating the access authority of the user device to the plurality of IPs, an authentication controller configured to determine, based on the security mode, whether to allow access of the user device to the plurality of IPs, and an access controller configured to activate or deactivate the access of the user device to the plurality of IPs based on a result of the determination of the authentication controller.

### BRIEF DESCRIPTION OF THE DRAWINGS

Implementations will be more clearly understood from the following detailed description taken in conjunction with the accompanying drawings.

FIG. 1 is a block diagram illustrating an example of a security system.

FIG. 2 is a block diagram illustrating an example of a system-on-chip (SoC) including a security device.

FIG. 3 is a diagram illustrating an example of a security mode corresponding to a one-time programmable (OTP) value of a security device.

FIG. 4 is a block diagram illustrating another example of an SoC including a security device.

FIG. 5 is a diagram illustrating an example of an OTP value and a security mode corresponding to a plurality of intellectual properties (IPs) connected to a security device.

FIG. 6 is a flowchart illustrating an example of an operating method of a security device.

FIG. 7 is an example flowchart illustrating the operation of a user device and a security device when the security mode of the security device is a first security mode.

FIG. 8 is an example flowchart illustrating the operation of a user device and a security device when the security mode of the security device is a second security mode.

FIG. 9 is an example flowchart illustrating the operation of an authentication server, a user device, and a security device when the security mode of the security device is a third security mode.

FIG. 10 is an example flowchart illustrating the operation of an authentication server, a user device, and a security device when the security mode of the security device is a fourth security mode.

### DETAILED DESCRIPTION

Hereinafter, Implementations will be described in detail with reference to the accompanying drawings.

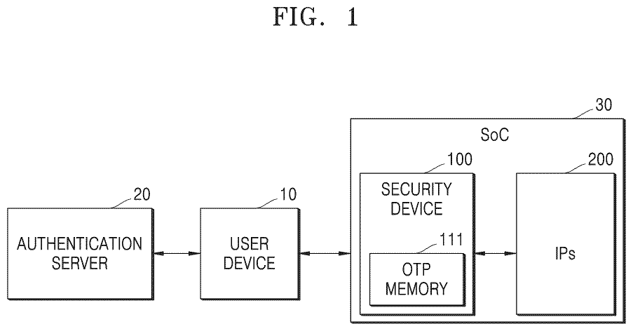

FIG. 1 is a block diagram illustrating an example of a security system.

Referring to FIG. 1, a security system may include a user device 10, an authentication server 20, and a system-on-chip (SoC) 30.

The security system may be a system including components necessary for a user to perform debugging on a plurality of intellectual properties (IPs) 200 included in the SoC 30.

The user device 10 may include hardware, software, or firmware for debugging the plurality of IPs 200 included in the SoC 30. The user may input data necessary to authenticate the access authority of the user to the plurality of IPs 200 included in the SoC 30, through the user device 10 to the security device 100 included in the SoC 30. For example, the user may input a password through the user device 10 to the security device 100 included in the SoC 30.

The authentication server 20 may be a server for generating a digital signature used to authenticate the access authority of the user device 10 to the plurality of IPs 200 included in the SoC 30. For example, when receiving an identification (ID) from the user device 10, the authentication server 20 may identify the authority of a user corresponding to the ID and generate a digital signature corresponding to the user.

The SoC 30 may include the security device 100 and the plurality of IPs 200.

The security device 100 may provide a function of driving all external pins of the plurality of IPs 200 included in the SoC 30 or reading values therefrom. The security device 100 may provide an interface for performing debugging on the plurality of IPs 200, to the user device 10 used by the user whose access authority have been authenticated.

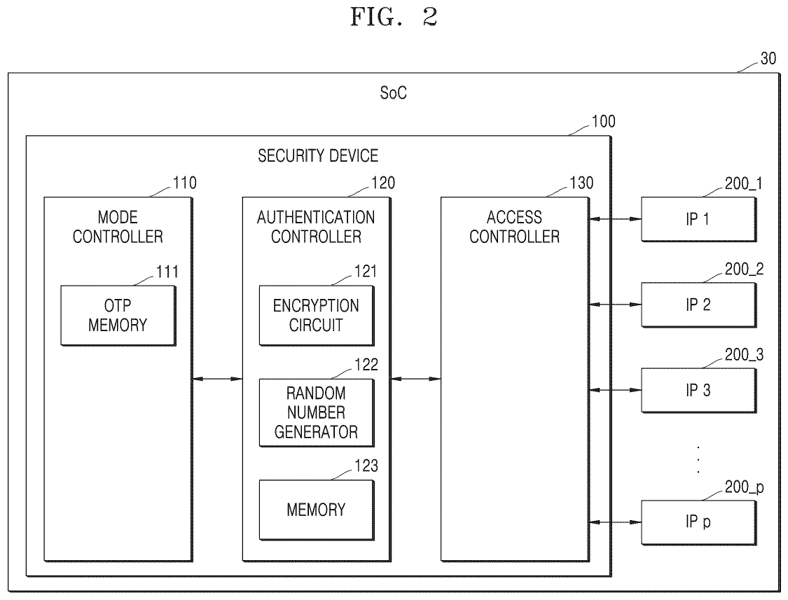

In some implementations, the security device 100 may include a one-time programmable (OTP) memory 111 for storing an OTP value. The OTP value may be a value used to set a security mode indicating a method of authenticating the access authority of the user device 10. The security device 100 may set a security mode based on the OTP value and determine whether to allow the access of the user device 10, based on the security mode. More detailed operations of the security device 100 will be described below with reference to FIG. 2.

The plurality of IPs 200 may include a device for processing at least one operation necessary to perform various operations of the SoC 30 and may include, for example, an application processor (AP). The plurality of IPs 200 may be debugged through the user device 10.

FIG. 2 is a block diagram illustrating an example of an SoC including a security device.

Referring to FIG. 2, an SoC 30 according to some implementations may include a security device 100 and first to pth IPs 200_1 to 200_p (where “p” is a natural number of 2 or more).

The security device 100 may include a mode controller 110, an authentication controller 120, and an access controller 130.

In some implementations, the mode controller 110 may set a security mode indicating a method of authenticating the access authority of the user device 10 based on an OTP value.

The OTP value may be a value indicating which security mode is a security mode indicating a method of authenticating the access authority of the user device 10 by the authentication controller 120. The OTP value may be stored in an OTP memory 111 included in the mode controller 110.

In some implementations, a value of each of the bits included in the OTP value may be changeable in one direction. Here, the one direction may refer to any one of a direction in which a value of each of the bits included in the OTP value increases and a direction in which the value decreases. Each of the bits included in the OTP value may have any one of a first logic value (e.g., logic 1) and a second logic value (e.g., logic 0). In this case, the bits included in the OTP value may all be initially set to have the second logic value and may be changed from the second logic value to have the first logic value but may not be changed from the first logic value to have the second logic value.

For example, the OTP memory 111 may store the values of the bits included in the OTP value through a plurality of fuses. When physically connected, each of the plurality of fuses may indicate the second logic value. On the contrary, when physically disconnected, each of the plurality of fuses may indicate the first logic value. In this case, the plurality of fuses may not be reconnected after being physically disconnected. Thus, each of the plurality of fuses may be changed from the state of indicating the second logic value to the state of indicating the first logic value but may not be changed from the state of indicating the first logic value to the state of indicating the second logic value.

In some implementations, the OTP value may include (n−1) bits (where “n” is a natural number of 2 or more). In this case, the mode controller 110 may set the security mode to any one of first to nth security modes based on the number of bits with the first logic value among the bits included in the OTP value. For example, when the number of bits with the first logic value among the bits included in the OTP value is 0, the mode controller 110 may set the security mode to the first security mode. Also, when the number of bits with the first logic value among the bits included in the OTP value is 1, the mode controller 110 may set the security mode to the second security mode. Also, when the number of bits with the first logic value among the bits included in the OTP value is k (where “k” is a natural number of 0 to (n−1)), the mode controller 110 may set the security mode to a (k+1)th security mode.

When the OTP value is changed, the mode controller 110 may change the security mode based on the changed OTP value. In this case, the bits included in the OTP value may be changed from the second logic value to the first logic value but may not be changed from the first logic value to the second logic value. Accordingly, the number of bits with the first logic value among the bits included in the OTP value may increase but may not decrease. Thus, the mode controller 110 may change the security mode in a direction in which the index of the security mode (“k” in the case of a kth security mode) increases but may not change the security mode in a direction in which the index of the security mode decreases.

In this case, an ith security mode (where “i” is a natural number of 2 to n) may have higher security strength than a jth security mode (where “j” is a natural number of 1 to (n−1) and is less than “i”). Here, the high security strength may mean that a procedure required to authenticate the access authority of the user device 10 is complex. That is, the mode controller 110 may change the security mode in a direction in which the procedure required to authenticating the access authority becomes more complex.

The user may change the security mode of the security device 100 by changing the OTP value stored in the OTP memory 111 by physically disconnecting a plurality of fuses included in the OTP memory 111. Because the value of each of the bits included in the OTP value may be changed in one direction, the user may change the security mode to increase the security strength of the security device 100. In this case, by performing debugging on the first to pth IPs 200_1 to 200_p included in the SoC 30 and then changing the OTP value stored in the OTP memory 111, the user may change the security mode in a direction in which the security strength of the security device 100 increases.

Accordingly, the user may perform debugging in a security mode with relatively low security strength before performing debugging on the first to pth IPs 200_1 to 200_p, thus allowing more convenient authentication, and may set the security mode to have higher security strength by changing the OTP value after performing debugging on the first to pth IPs 200_1 to 200_p, thereby allowing the debugged details of the first to pth IPs 200_1 to 200_p to be more securely protected.

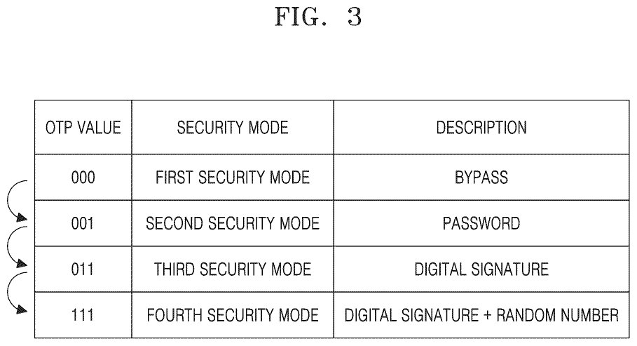

In some implementations, the security mode may include first to fourth security modes, and the mode controller 110 may set the security mode to any one of the first to fourth security modes according to the OTP value. When the security mode includes the first to fourth security modes, an example of the security mode depending on the OTP value and an operation method of the security mode may be as illustrated in FIG. 3.

FIG. 3 is a diagram illustrating an example of a security mode corresponding to an OTP value of a security device.

Referring to FIG. 3, a table illustrating a security mode depending on the OTP value and an operation method of the security mode may be identified. In the following description with reference to FIG. 3, the first logic value may refer to logic 1 and the second logic value may refer to logic 0; however, the present disclosure is not limited thereto.

First, when the OTP value includes 0 (no) bit with the first logic value like “000”, the mode controller 110 may set the security mode to the first security mode. In this case, the first security mode may also be referred to as a bypass mode and may be a mode in which the security device 100 allows the access of the user device 10 without separate authentication. That is, when the security mode is the first security mode, the user may perform debugging on the plurality of IPs 200 included in the SoC 30 even without performing separate authentication.

When the OTP value includes 1 bit with the first logic value like “001”, the mode controller 110 may set the security mode to the second security mode. In this case, the second security mode may be a mode in which the security device 100 determines whether to allow the access of the user device 10, through authentication using a password. That is, when the security mode is the second security mode, the user may perform debugging on the plurality of IPs 200 included in the SoC 30 by performing authentication using a password.

When the OTP value includes 2 bits with the first logic value like “011”, the mode controller 110 may set the security mode to the third security mode. In this case, the third security mode may be a mode in which the security device 100 determines whether to allow the access of the user device 10, through authentication using a digital signature. That is, when the security mode is the third security mode, the user may perform debugging on the plurality of IPs 200 included in the SoC 30 by performing authentication using a digital signature generated through the authentication server 20.

When the OTP value includes 3 bits with the first logic value like “111”, the mode controller 110 may set the security mode to the fourth security mode. In this case, the fourth security mode may be a mode in which the security device 100 determines whether to allow the access of the user device 10, through authentication using a digital signature and a random value. That is, when the security mode is the fourth security mode, the user may perform debugging on the plurality of IPs 200 included in the SoC 30 by performing authentication using a random value generated by the security device 100 and a digital signature generated through the authentication server 20.

In this case, as illustrated by the arrows on the left side of the table in FIG. 3, the value of each of the bits included in the OTP value may be changed in one direction (from the first logic value to the second logic value).

Hereinafter, the description will focus on some implementations in which the security mode includes the first to fourth security modes as illustrated in FIG. 3; however, the present disclosure is not limited thereto.

Referring back to FIG. 2, the authentication controller 120 may determine whether to allow the access of the user device 10, based on the security mode set by the mode controller 110.

The authentication controller 120 may include an encryption circuit 121, a random number generator 122, and a memory 123.

The encryption circuit 121 may perform an operation related to determining whether to allow the access of the user device 10. For example, the encryption circuit 121 may generate a hash value of the password by performing a hash operation on the password received from the user device 10 and determine whether to allow the access of the user device 10, by determining whether the hash value of the password is equal to a prestored value.

The random number generator 122 may generate a random value used when the security mode set by the mode controller 110 is the fourth security mode.

The memory 123 may store software used to operate the encryption circuit 121, the hash value of the password, the random value generated by the random number generator 122, and/or the like.

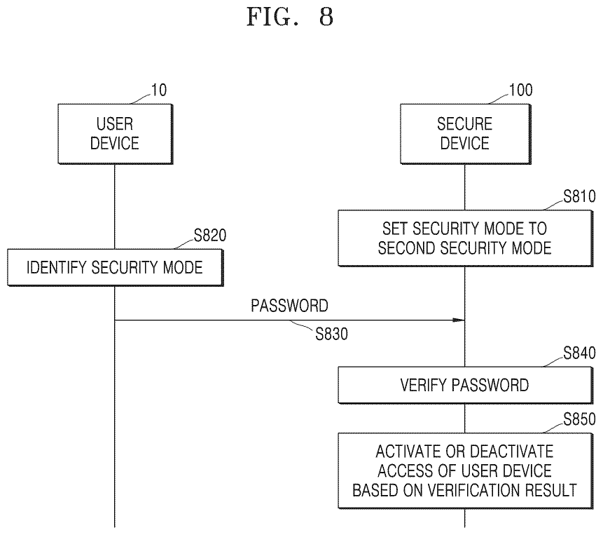

In some implementations, when the security mode is the second security mode, the authentication controller 120 may determine whether to allow the access of the user device 10, based on the password. When the security mode is the third security mode, the authentication controller 120 may determine whether to allow the access of the user device 10, based on the digital signature. When the security mode is the fourth security mode, the authentication controller 120 may determine whether to allow the access of the user device 10, based on the digital signature set based on the random value. A more detailed method of determining whether to allow the access of the user device 10 through the authentication controller 120 in each security mode will be described below with reference to FIGS. 8 to 10.

The access controller 130 may activate or deactivate the access of the user device 10 based on the determination result of the authentication controller 120. When the authentication controller 120 determines to allow the access of the user device 10, the access controller 130 may activate the access of the user device 10. On the contrary, when the authentication controller 120 determines not to allow the access of the user device 10, the access controller 130 may deactivate the access of the user device 10.

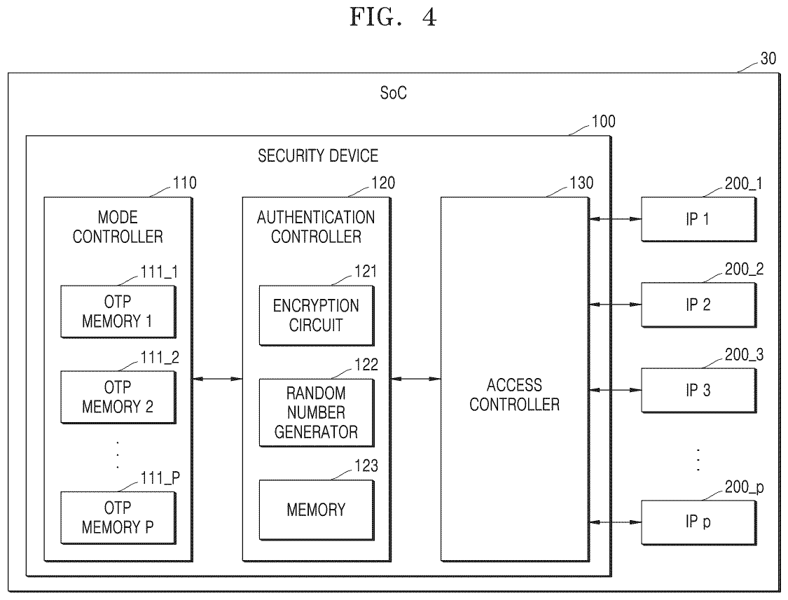

FIG. 4 is a block diagram illustrating another example of an SoC including a security device.

Referring to FIG. 4, an SoC 30 according to some implementations may include a security device 100 and first to pth IPs 200_1 to 200_p. The security device 100 may include a mode controller 110, an authentication controller 120, and an access controller 130. Because the main operations of the SoC 30 of FIG. 4 are similar to those described with reference to FIG. 2, the description will focus on differences therebetween.

In the implementation of FIG. 4, the mode controller 110 may include first to pth OTP memories 111_1 to 111_p. Each of the first to pth OTP memories 111_1 to 111_p may store first to pth OTP values. In this case, the number of first to pth OTP memories 111_1 to 111_p may be equal to the number of first to pth IPs 200_1 to 200_p. That is, the number of first to pth OTP values may be equal to the number of first to pth IPs 200_1 to 200_p.

Each of the first to pth OTP values may be a value indicating which security mode is a security mode indicating a method of authenticating the access authority of the user device 10 to each of the first to pth IPs 200_1 to 200_p by the authentication controller 120. For example, the first OTP value may indicate which security mode is a security mode indicating a method of authenticating the access authority of the user device 10 to the first IP, and an mth OTP value (where “m” is a natural number of 1 to p) may indicate which security mode is a security mode indicating a method of authenticating the access authority of the user device 10 to an mth IP.

The value of each of the bits included in the first to pth OTP values may be changeable in one direction. Each of the bits included in the first to pth OTP values may have any one of a first logic value (e.g., logic 1) and a second logic value (e.g., logic 0). In this case, the bits included in the first to pth OTP values may all be initially set to have the second logic value and may be changed from the second logic value to have the first logic value but may not be changed from the first logic value to have the second logic value.

In some implementations, each of the first to pth OTP values may include (n−1) bits (where “n” is a natural number of 2 or more). In this case, the mode controller 110 may set the security mode for the first to pth IPs 200_1 to 200_p to any one of first to nth security modes, based on the number of bits with the first logic value among the bits included in each of the first to pth OTP values. For example, when the number of bits with the first logic value among the bits included in the mth OTP value is 0, the mode controller 110 may set the security mode for the mth IP to the first security mode. Also, when the number of bits with the first logic value among the bits included in the mth OTP value is 1, the mode controller 110 may set the security mode for the mth IP to the second security mode. Also, when the number of bits with the first logic value among the bits included in the mth OTP value is k (where “k” is a natural number of 0 to (n−1)), the mode controller 110 may set the security mode for the mth IP to a (k+1) th security mode. That is, the mode controller 110 may independently set the security mode for the first to pth IPs 200_1 to 200_p.

In some implementations, when any one of the first to pth OTP values is changed, the mode controller 110 may change the security mode based on the changed OTP value among the first to pth OTP values. For example, when the mth OTP value is changed, the mode controller 110 may change the security mode for the mth IP 200_m corresponding to the mth OTP value.

In some implementations, the authentication controller 120 may determine whether to allow the access of the user device 10 to each of the first to pth IPs 200_1 to 200_p, based on the security mode. That is, the authentication controller 120 may independently determine whether to allow the access of the user device 10 to each of the first to pth IPs 200_1 to 200_p, based on the security mode set for each of the first to pth IPs 200_1 to 200_p.

In some implementations, the authentication controller 120 may sequentially determine whether to allow the access of the user device 10 to each of the first to pth IPs 200_1 to 200_p, based on the security mode of each of the first to pth IPs 200_1 to 200_p. For example, the authentication controller 120 may determine whether to allow the access of the user device 10 to the first IP 200_1 and then determine whether to allow the access of the user device 10 to the second IP 200_2. However, the present disclosure is not limited thereto, and when a plurality of cores are included in the authentication controller 120, the authentication controller 120 may simultaneously determine whether to allow the access of the user device 10 to each of the first to pth IPs 200_1 to 200_p.

The access controller 130 may activate or deactivate the access of the user device 10 to each of the first to pth IPs 200_1 to 200_p based on the determination result of the authentication controller 120. The access controller 130 may independently determine whether to activate the access to each of the first to pth IPs 200_1 to 200_p, based on the determination result of the authentication controller 120.

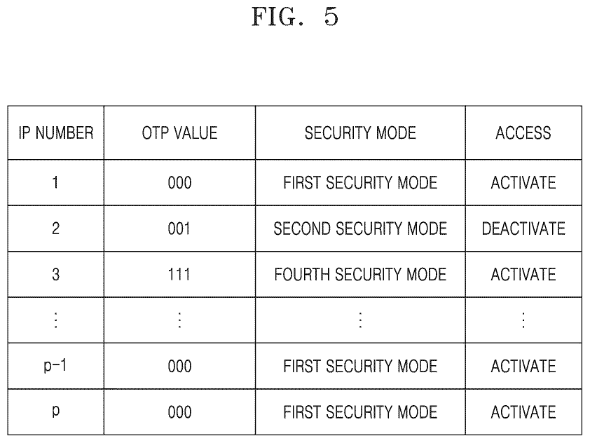

FIG. 5 is a diagram illustrating an example of an OTP value and a security mode corresponding to a plurality of IPs connected to a security device.

Referring to FIG. 5, a table illustrating an OTP value corresponding to the number of each of the first to pth IPs 200_1 to 200_p included in the security device 100, a security mode depending on the OTP value, and access activation/deactivation may be identified. In the following description with reference to FIG. 5, the first logic value may refer to logic 1 and the second logic value may refer to logic 0; however, the present disclosure is not limited thereto.

First, the first OTP value stored in the first OTP memory 111_1 corresponding to the first IP 200_1 may include 0 (no) bit with the first logic value like “000”, and accordingly, the mode controller 110 may set the security mode for the first IP 200_1 to the first security mode. In this case, because the security mode for the first IP 200_1 is the first security mode, the access of the user device 10 to the first IP 200_1 may be activated without separate authentication.

The second OTP value stored in the second OTP memory 111_2 corresponding to the second IP 200_2 may include 1 bit with the first logic value like “001”, and accordingly, the mode controller 110 may set the security mode for the second IP 200_2 to the second security mode. In this case, because the security mode for the second IP 200_2 is the second security mode, the security device 100 may determine whether to allow the access of the user device 10, based on the password. In this case, when it is determined that the access is not allowed, the access of the user device 10 to the second IP 200_2 may be deactivated as illustrated in the table.

The third OTP value stored in the third OTP memory 111_3 corresponding to the third IP 200_3 may include 3 bits with the first logic value like “111”, and accordingly, the mode controller 110 may set the security mode for the third IP 200_3 to the fourth security mode. In this case, because the security mode for the third IP 200_3 is the fourth security mode, the security device 100 may determine whether to allow the access of the user device 10, based on the random value and the digital signature. In this case, when it is determined that the access is allowed, the access of the user device 10 to the third IP 200_3 may be activated as illustrated in the table.

The same method may also be applied to the fourth to pth IPs 200_4 to 200_p.

As illustrated in FIG. 5, the security mode for each of the first to pth IPs 200_1 to 200_p may be independently set, and whether to allow the access of the user device 10 to each of the first to pth IPs 200_1 to 200_p may also be independently determined.

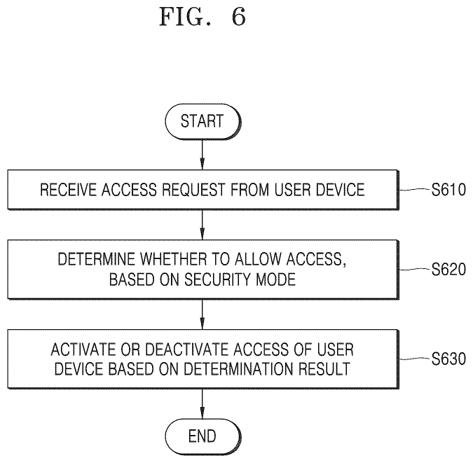

FIG. 6 is a flowchart illustrating an example of an operating method of a security device.

In FIG. 6 and below, the configuration of the security device 100 will be described focusing on the implementation illustrated in FIG. 2; however, in the following descriptions, the configuration of the security device 100 may also be similarly applied to the implementation illustrated in FIG. 4.

Referring to FIG. 6, in operation S610, the security device 100 may receive an access request from the user device 10. The access request may be a request of the user device 10 for allowing access for performing debugging on the plurality of IPs 200 included in the security device 100 and may include information required for authentication corresponding to the security mode set by the mode controller 110.

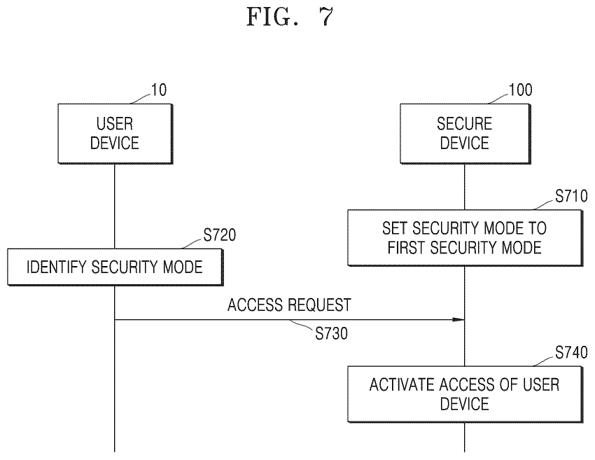

In operation S620, the security device 100 may determine whether to allow the access, based on the security mode. The security device 100 may determine whether to allow the access of the user device 10 to the plurality of IPs 200, through the authentication controller 120, and a more detailed method thereof will be described below with reference to FIGS. 7 to 10.

In operation S630, the security device 100 may activate or deactivate the access of the user device 10 based on the determination result of operation S620. When it is determined in operation S620 to allow the access of the user device 10 to the plurality of IPs 200, the security device 100 may activate the access of the user device 10 through the access controller 130. On the contrary, when it is determined in operation S620 not to allow the access of the user device 10 to the plurality of IPs 200, the security device 100 may deactivate the access of the user device 10 through the access controller 130.

FIG. 7 is an example flowchart illustrating the operation of a user device and a security device when the security mode of the security device is a first security mode.

Referring to FIG. 7, when the security mode of the security device is the first security mode, the operation of the user device and the security device may be identified. The implementation of FIG. 7 will be described focusing on the main operations of the user device and the security device; however, incidental operations may be added thereto.

In operation S710, the security device 100 may set the security mode to the first security mode. The security device 100 may set the security mode based on the OTP value stored in the OTP memory 111 included in the mode controller 110. In the implementation of FIG. 7, the OTP value stored in the OTP memory 111 may be “000”, and the mode controller 110 may set the security mode to the first security mode because the OTP value is “000”.

In operation S720, the user device 10 may identify the security mode of the security device 100, and accordingly, it may be identified that the security mode of the security device 100 is the first security mode.

In operation S730, the user device 10 may transmit an access request to the security device 100. In this case, because the security mode of the security device 100 is the first security mode, the user device 10 may transmit the access request without separate information required for authentication.

In operation S740, the security device 100 may activate the access of the user device 10. In this case, because the security mode of the security device 100 is the first security mode, the authentication controller 120 may determine to allow the access without performing separate authentication, and accordingly, the access controller 130 may activate the access of the user device 10.

FIG. 8 is an example flowchart illustrating the operation of a user device and a security device when the security mode of the security device is a second security mode.

Referring to FIG. 8, when the security mode of the security device is the second security mode, the operation of the user device and the security device may be identified. The implementation of FIG. 8 will be described focusing on the main operations of the user device and the security device; however, incidental operations may be added thereto.

In operation S810, the security device 100 may set the security mode to the second security mode. The security device 100 may set the security mode based on the OTP value stored in the OTP memory 111 included in the mode controller 110. In the implementation of FIG. 8, the OTP value stored in the OTP memory 111 may be “001”, and the mode controller 110 may set the security mode to the second security mode because the OTP value is “001”.

In operation S820, the user device 10 may identify the security mode of the security device 100, and accordingly, it may be identified that the security mode of the security device 100 is the second security mode.

In operation S830, the user device 10 may transmit a password to the security device 100. In this case, because the security mode of the security device 100 is the second security mode, the access authority of the user device 10 may be authenticated through the password.

In operation S840, the security device 100 may verify the password. The security device 100 may perform a hash operation on the password through the encryption circuit 121 of the authentication controller 120. The encryption circuit 121 may verify the password by determining whether the hash value of the password is equal to a prestored hash value.

In this case, when the hash value of the password obtained through the operation is equal to the prestored hash value, the encryption circuit 121 may determine to allow the access of the user device 10. On the contrary, when the hash value of the password obtained through the operation is different from the prestored hash value, the encryption circuit 121 may determine not to allow the access of the user device 10.

In operation S850, the security device 100 may activate or deactivate the access of the user device 10 based on the verification result.

When it is determined in operation S840 to allow the access of the user device 10, the security device 100 may activate the access of the user device 10 through the access controller 130. On the contrary, when it is determined in operation S840 not to allow the access of the user device 10, the security device 100 may deactivate the access of the user device 10 through the access controller 130.

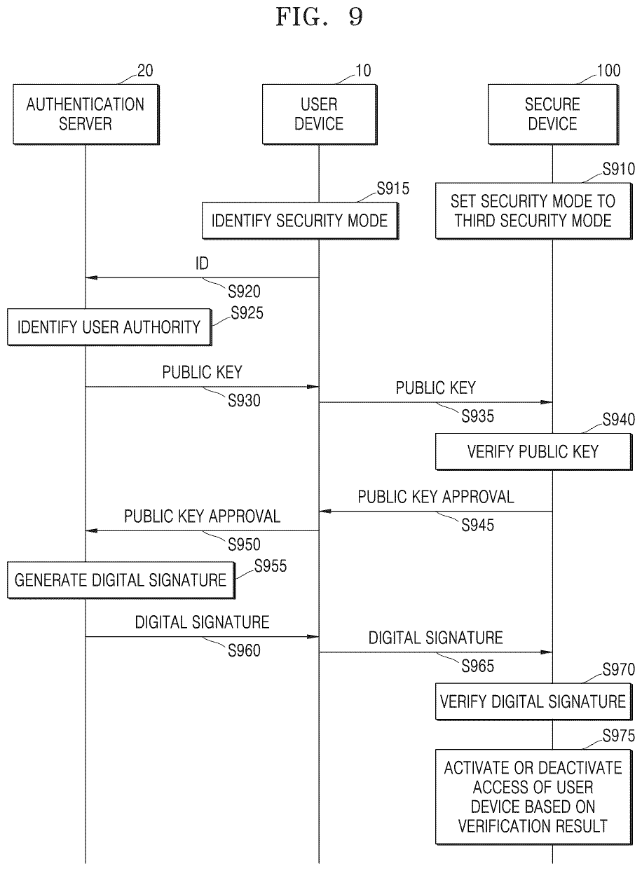

FIG. 9 is an example flowchart illustrating the operation of an authentication server, a user device, and a security device when the security mode of the security device is a third security mode.

Referring to FIG. 9, when the security mode of the security device is the third security mode, the operation of the authentication server, the user device, and the security device may be identified. The implementation of FIG. 9 will be described focusing on the main operations of the authentication server, the user device, and the security device; however, incidental operations may be added thereto.

In operation S910, the security device 100 may set the security mode to the third security mode. The security device 100 may set the security mode based on the OTP value stored in the OTP memory 111 included in the mode controller 110. In the implementation of FIG. 9, the OTP value stored in the OTP memory 111 may be “011”, and the mode controller 110 may set the security mode to the third security mode because the OTP value is “011”.

In operation S915, the user device 10 may identify the security mode of the security device 100, and accordingly, it may be identified that the security mode of the security device 100 is the third security mode.

In operation S920, the user device 10 may transmit a user ID to the authentication server 20.

In operation S925, the authentication server 20 may identify the user authority based on the user ID. The user authority may be the authority for allowing the user corresponding to the user ID to access the security device 100. In this case, when the authentication server 20 identifies that the user does not have the authority, subsequent operations may not be performed. When the authentication server 20 identifies that the user has the authority, operation S930 and subsequent operations may be performed.

In operation S930, the authentication server 20 may transmit a public key to the user device 10.

In operation S935, the user device 10 may transmit the public key received in operation S930 to the security device 100.

In operation S940, the security device 100 may verify the public key. The security device 100 may verify whether the public key is correct, through the encryption circuit 121. In this case, when the encryption circuit 121 determines that the public key is not correct, subsequent operations may not be performed. On the contrary, when the encryption circuit 121 identifies that the public key is correct, operation S945 and subsequent operations may be performed.

In operation S945, the security device 100 may transmit a public key approval message to the user device 10 as the public key is verified as being correct in operation S940.

In operation S950, the user device 10 may transmit the public key approval message received in operation S945 to the authentication server 20.

In operation S955, the authentication server 20 may generate a digital signature corresponding to the user ID upon receiving the public key approval message. For example, the authentication server 20 may generate a digital signature by using an Elliptic Curve Digital Signature Algorithm (ECDSA) method.

In operation S960, the authentication server 20 may transmit the digital signature generated in operation S955 to the user device 10.

In operation S965, the user device 10 may transmit the digital signature received in operation S960 to the security device 100.

In operation S970, the security device 100 may verify the digital signature. The security device 100 may verify whether the digital signature is correct through the encryption circuit 121.

When the digital signature is identified as being correct, the encryption circuit 121 may determine to allow the access of user device 10. On the contrary, when the digital signature is identified as not being incorrect, the encryption circuit 121 may determine not to allow the access of the user device 10.

In operation S975, the security device 100 may activate or deactivate the access of the user device 10 based on the verification result.

When it is determined in operation S970 to allow the access of the user device 10, the security device 100 may activate the access of the user device 10 through the access controller 130. On the contrary, when it is determined in operation S970 not to allow the access of the user device 10, the security device 100 may deactivate the access of the user device 10 through the access controller 130.

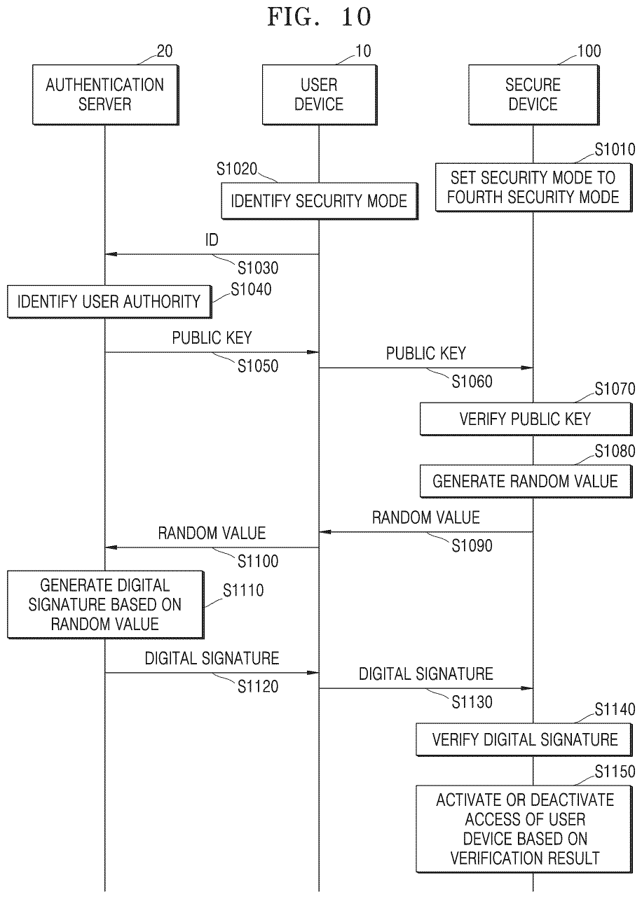

FIG. 10 is an example flowchart illustrating the operation of an authentication server, a user device, and a security device when the security mode of the security device is a fourth security mode.

Referring to FIG. 10, when the security mode of the security device is the fourth security mode, the operation of the authentication server, the user device, and the security device may be identified. The implementation of FIG. 10 will be described focusing on the main operations of the authentication server, the user device, and the security device; however, incidental operations may be added thereto.

In operation S1010, the security device 100 may set the security mode to the fourth security mode. The security device 100 may set the security mode based on the OTP value stored in the OTP memory 111 included in the mode controller 110. In the implementation of FIG. 10, the OTP value stored in the OTP memory 111 may be “111”, and the mode controller 110 may set the security mode to the fourth security mode because the OTP value is “111”.

In operation S1020, the user device 10 may identify the security mode of the security device 100, and accordingly, it may be identified that the security mode of the security device 100 is the fourth security mode.

In operation S1030, the user device 10 may transmit a user ID to the authentication server 20.

In operation S1040, the authentication server 20 may identify the user authority based on the user ID. In this case, when the authentication server 20 identifies that the user does not have the authority, subsequent operations may not be performed. When the authentication server 20 identifies that the user has the authority, operation S1050 and subsequent operations may be performed.

In operation S1050, the authentication server 20 may transmit a public key to the user device 10.

In operation S1060, the user device 10 may transmit the public key received in operation S1050 to the security device 100.

In operation S1070, the security device 100 may verify the public key. The security device 100 may verify whether the public key is correct, through the encryption circuit 121. In this case, when the encryption circuit 121 determines that the public key is not correct, subsequent operations may not be performed. On the contrary, when the encryption circuit 121 identifies that the public key is correct, operation S1080 and subsequent operations may be performed.

In operation S1080, the security device 100 may generate a random value. The security device 100 may generate a random value through the random number generator 122 of the authentication controller 120.

In operation S1090, the security device 100 may transmit the random value generated in operation S1080 to the user device 10.

In operation S1100, the user device 10 may transmit the random value received in operation S1090 to the authentication server 20.

In operation S1110, the authentication server 20 may generate a digital signature based on the random value. For example, the authentication server 20 may generate a digital signature by using an ECDSA method.

In operation S1120, the authentication server 20 may transmit the digital signature generated in operation S1110 to the user device 10.

In operation S1130, the user device 10 may transmit the digital signature received in operation S1120 to the security device 100.

In operation S1140, the security device 100 may verify the digital signature. The security device 100 may verify whether the digital signature is correct through the encryption circuit 121.

When the digital signature is identified as being correct, the encryption circuit 121 may determine to allow the access of user device 10. On the contrary, when the digital signature is identified as not being incorrect, the encryption circuit 121 may determine not to allow the access of the user device 10.

In operation S1150, the security device 100 may activate or deactivate the access of the user device 10 based on the verification result.

When it is determined in operation S1140 to allow the access of the user device 10, the security device 100 may activate the access of the user device 10 through the access controller 130. On the contrary, when it is determined in operation S1140 not to allow the access of the user device 10, the security device 100 may deactivate the access of the user device 10 through the access controller 130.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been shown and described with reference to implementations thereof, it will be understood that various changes in form and details may be made therein without departing from the spirit and scope of the following claims.

What is claimed is:

1. A security device configured to control access authority of a user device, the security device comprising:
a mode controller configured to set, based on a one-time programmable (OTP) value, a security mode, the security mode indicating a method of authenticating the access authority of the user device;
an authentication controller configured to determine, based on the security mode, whether to allow access of the user device; and
an access controller configured to activate or deactivate the access of the user device based on a result of the determination of the authentication controller.

2. The security device of claim 1, wherein the OTP value includes one or more bits, and a value of each bit of the one or more bits is changeable in an increasing direction or a decreasing direction.

3. The security device of claim 2, wherein the mode controller is configured to change the security mode based on the OTP value being changed.

4. The security device of claim 3, wherein the OTP value includes n−1 bits, n being a natural number greater than or equal to 2, and
wherein the mode controller is configured to set the security mode to one of first to n^{th} security modes based on a number of bits with a first logic value among the n−1 bits included in the OTP value.

5. The security device of claim 4, wherein the number of bits with the first logic value among the n−1 bits included in the OTP value is k, k being a natural number of 0 to n−1, wherein the mode controller is configured to set the security mode to a (k+1)^{th} security mode, and
wherein an i^{th} security mode has higher security strength than a j^{th} security mode, i being a natural number of 2 to n, j being a natural number of 1 to n−1, and j being less than i.

6. The security device of claim 1, wherein the mode controller is configured to set the security mode to one of first to fourth security modes based on the OTP value,
wherein the first security mode is a mode of allowing the access of the user device without authentication,
wherein the second security mode is a mode of authenticating the access authority of the user device by using a password,
wherein the third security mode is a mode of authenticating the access authority of the user device by using a digital signature, and
wherein the fourth security mode is a mode of authenticating the access authority of the user device by using the digital signature and a random value.

7. The security device of claim 6, wherein the authentication controller is configured to
based on the security mode being the second security mode, determine whether to allow the access of the user device based on the password,
based on the security mode being the third security mode, determine whether to allow the access of the user device based on the digital signature, and
based on the security mode being the fourth security mode, determine whether to allow the access of the user device based on the digital signature and the random value.

8. A security device configured to control access authority of a user device to a plurality of intellectual properties (IPs), the security device comprising:
a mode controller configured to set a security mode of the user device for each IP of the plurality of IPs based on each one-time programmable (OTP) value of a plurality of OTP values;
an authentication controller configured to determine, based on the security mode, whether to allow access of the user device to each IP of the plurality of IPs; and
an access controller configured to activate or deactivate the access of the user device to each IP of the plurality of IPs based on a result of the determination of the authentication controller.

9. The security device of claim 8, wherein each OTP value of the plurality of OTP values includes one or more bits, and a value of each bit of the one or more bits is changeable in an increasing direction or a decreasing direction.

10. The security device of claim 8, wherein a number of the plurality of OTP values equals to a number of the plurality of IPs, and
wherein based on an m^{th} OTP value being changed, the mode controller is configured to change the security mode for an m^{th} IP corresponding to the m^{th} OTP value, m being a natural number.

11. The security device of claim 10, wherein each OTP value of the plurality of OTP values includes n−1 bits, n being a natural number greater than or equal to 2, and
wherein the mode controller is configured to set the security mode for the m^{th} IP to one of first to n^{th} security modes based on a number of bits with a first logic value among the n−1 bits included in the m^{th} OTP value.

12. The security device of claim 11, wherein the number of bits with the first logic value among the n−1 bits included in the mth OTP value is k, k being a natural number of 0 to n−1, wherein the mode controller is configured to set the security mode to a (k+1)^{th} security mode, and
wherein an i^{th} security mode has higher security strength than a j^{th} security mode, i being a natural number of 2 to n, j being a natural number of 1 to n−1, and j being less than i.

13. The security device of claim 8, wherein the mode controller is configured to set the security mode for an m^{th} IP to one of first to fourth security modes based on an m^{th} OTP value, m being a natural number,
wherein the first security mode is a mode of allowing the access of the user device to each IP of the plurality of IPs without authentication,
wherein the second security mode is a mode of authenticating the access authority of the user device to each IP of the plurality of IPs by using a password,
wherein the third security mode is a mode of authenticating the access authority of the user device to each IP of the plurality of IPs by using a digital signature, and
wherein the fourth security mode is a mode of authenticating the access authority of the user device to each IP of the plurality of IPs by using the digital signature and a random value.

14. The security device of claim 13, wherein the authentication controller is configured to
based on the security mode being the second security mode, determine whether to allow the access of the user device to each IP of the plurality of IPs based on the password,
based on the security mode being the third security mode, determine whether to allow the access of the user device to each IP of the plurality of IPs based on the digital signature, and
based on the security mode being the fourth security mode, determine whether to allow the access of the user device to each IP of the plurality of IPs based on the digital signature and the random value.

15. The security device of claim 8, wherein the authentication controller is configured to sequentially determine whether to allow the access of the user device to each IP of the plurality of IPs based on the security mode of each IP of the plurality of IPs.

16. The security device of claim 8, wherein the access controller is configured to independently activate or deactivate the access of the user device to each IP of the plurality of IPs.

17. A system-on-chip (SoC) comprising:
a plurality of intellectual properties (IPs); and
a security device configured to control access authority of a user device to the plurality of IPs,
wherein the security device comprises:
a mode controller configured to set, based on a one-time programmable (OTP) value, a security mode, the security mode indicating a method of authenticating the access authority of the user device to the plurality of IPs;
an authentication controller configured to determine, based on the security mode, whether to allow access of the user device to the plurality of IPs; and
an access controller configured to activate or deactivate the access of the user device to the plurality of IPs based on a result of the determination of the authentication controller.

18. The SoC of claim 17, wherein the OTP value includes one or more bits, and a value of each bit of the one or more bits is changeable in an increasing direction or a decreasing direction.

19. The SoC of claim 18, wherein the mode controller is configured to change the security mode based on the OTP value being changed.

20. The SoC of claim 17, wherein the mode controller is configured to set the security mode to one of first to fourth security modes based on the OTP value,
wherein the first security mode is a mode of allowing the access of the user device to the plurality of IPs without authentication,
wherein the second security mode is a mode of authenticating the access authority of the user device to the plurality of IPs by using a password,
wherein the third security mode is a mode of authenticating the access authority of the user device to the plurality of IPs by using a digital signature, and
wherein the fourth security mode is a mode of authenticating the access authority of the user device to the plurality of IPs by using the digital signature and a random value.
